(19) United States
(12) Patent Application Publication
(10) Pub. No.: US 2025/0212296 A1
(43) Pub. Date: Jun. 26, 2025

(54) DEVICE PROVIDING NOTIFICATION FOR URGENT CALL, AND METHOD THEREFOR

(71) Applicant: Samsung Electronics Co., Ltd., Suwon-si (KR)

(72) Inventors: Thi Phuong NGUYEN, Hanoi (VN); Duy Tung NGUYEN, Hanoi (VN); Van Thong DUONG, Hanoi (VN); Minh Ngoc NGUYEN, Hanoi (VN)

(21) Appl. No.: 19/078,773

(22) Filed: Mar. 13, 2025

Related U.S. Application Data
(63) Continuation of application No. PCT/KR2023/012339, filed on Aug. 21, 2023.

(30) Foreign Application Priority Data
Sep. 16, 2022 (KR) 10-2022-0117115

(51) Int. Cl. H04W 76/50; H04L 65/1104

(52) U.S. Cl. CPC H04W 76/50; H04L 65/1104

(57) ABSTRACT

A device providing a notification for an urgent call, and a method therefor are provided. The method comprises: receiving, from an SIP server, an SIP invite message for an urgent call, generated by a calling device; identifying, in response to receiving the SIP invite message, that an urgent notification function for notifying a user of the urgent call based on the SIP invite message is supported by the reception device; obtaining, in response to identifying that the urgent notification function is supported, urgent notification support information indicating that the urgent notification function is supported; transmitting, to the SIP server, an SIP response code for the SIP invite message together with the urgent notification support information, the transmitted SIP response code and urgent notification support information being provided from the SIP server to the calling device; and outputting, in response to the identifying that the urgent notification function is supported, an urgent notification indicating that the SIP invite message for the urgent call has been received.

### CROSS-REFERENCE TO RELATED APPLICATIONS

This application is a continuation of International Application No. PCT/KR2023/012339 designating the United States, filed on Aug. 21, 2023, in the Korean Intellectual Property Receiving Office and claiming priority to Korean Patent Application NO. 10-2022-0117115, filed on Sep. 16, 2022, in the Korean Intellectual Property Office, the disclosures of each of which are incorporated by reference herein in their entireties.

### BACKGROUND

### Field

The disclosure relates to a device which provides a notification for an urgent call and a method therefor.

### Description of Related Art

Recently, communication technologies are developing to be able to provide services to users using both voice and data, and users can use call services between users based on various types of multi-media data.

However, related-art call services have a limit to how users effectively notify other users of their urgency when they are in an emergency situation, and particularly, when a user requests a call connection to a device of another user using user's own device, there may be a problem that it is difficult for another user's device to effectively output an alarm notifying the user's urgency.

### SUMMARY

According to an example embodiments, there is provided a device that provides a notification for an urgent call from a transmission device, the device including: a communication interface comprising communication circuitry; a memory configured to store instructions; and at least one processor, comprising processing circuitry, operatively connected with the communication interface and the memory and configured to execute the instructions, wherein, at least one processor, individually and/or collectively may be configured to cause the electronic device to: receive a session initiation protocol (SIP) invite message for the urgent call generated at the transmission device from an SIP server; in response to the SIP invite message being received, identify that an urgent notification function of notifying a user of the urgent call based on the SIP invite message is supported by the device; in response to identifying that the urgent notification function is supported, acquire urgent notification support information indicating that the urgent notification function is supported; transmit a SIP response code as to the SIP invite message to the SIP server along with the urgent notification support information, the transmitted SIP response code and the urgent notification support information being provided to the transmission device from the SIP server; in response identifying that the urgent notification function is supported, output an urgent notification notifying that the SIP invite message for the urgent call is received; receive an input for connecting the urgent call; and establish a session for the urgent call with the transmission device.

According an example embodiment, there is provided a method of a reception device for providing a notification for an urgent call, the method including: receiving, from a session initiation protocol (SIP) server, an SIP invite message for the urgent call generated at a transmission device; in response to the SIP invite message being received, identifying that an urgent notification function of notifying a user of the urgent call based on the SIP invite message is supported by the reception device; in response to identifying that the urgent notification function is supported, acquiring urgent notification support information indicating that the urgent notification function is supported; transmitting an SIP response code as to the SIP invite message to the SIP server along with the urgent notification support information, the transmitted SIP response code and the urgent notification support information being provided to the transmission device from the SIP server; in response identifying that the urgent notification function is supported, outputting an urgent notification notifying that the SIP invite message for the urgent call is received; receiving an input for connecting the urgent call; and establishing a session for the urgent call with the transmission device.

According to an example embodiment, there is provided a non-transitory computer-readable recording medium having a program recorded thereon which, when executed by at least one processor, comprising processing circuitry, individually and/or collectively, of an electronic device, causes the electronic device to perform a method of a reception device for providing a notification for an urgent call, wherein the method includes: receiving, from a session initiation protocol (SIP) server, an SIP invite message for the urgent call generated at a transmission device; in response to the SIP invite message being received, identifying that an urgent notification function of notifying a user of the urgent call based on the SIP invite message is supported by the reception device; in response to identifying that the urgent notification function is supported, acquiring urgent notification support information indicating that the urgent notification function is supported; transmitting an SIP response code as to the SIP invite message to the SIP server along with the urgent notification support information, the transmitted SIP response code and the urgent notification support information being provided to the transmission device from the SIP server; in response to identifying that the urgent notification function is supported, outputting an urgent notification notifying that the SIP invite message for the urgent call is received; receiving an input for connecting the urgent call; and establishing a session for the urgent call with the transmission device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an urgent call notification system that enables a reception device to notify a user of an urgent call according to various embodiments;

FIG. 2 is a flowchart illustrating an example method of a reception device for providing a notification for an urgent call according to various embodiments;

FIG. 3 is a flowchart illustrating an example call connection method that enables a transmission device, a reception device, and a SIP server to output a notification for an urgent call at the reception device according to various embodiments;

FIG. 4 is a diagram illustrating an urgent call notification system that enables a reception device to notify an IoT device of an urgent call via an IoT server according to various embodiments;

FIG. 5 is a flowchart illustrating an example method of a reception device for providing an urgent notification to an IoT device via an IoT server according to various embodiments;

FIG. 6 is a diagram illustrating an urgent call notification system that enables a reception device to notify an IoT device of an urgent call according to various embodiments;

FIG. 7 is a flowchart illustrating an example method of a reception device for providing an urgent call to an IoT device according to various embodiments;

FIG. 8 is a diagram illustrating a screen of a transmission device when the transmission device transmits a call for an urgent notification according to various embodiments;

FIG. 9 is a diagram illustrating a screen of a reception device when the reception device supporting an urgent notification function receives an urgent call according to various embodiments;

FIG. 10 is a diagram illustrating a screen of a reception device when the reception device that does not support an urgent notification function receives an urgent call according to various embodiments; and

FIG. 11 is a block diagram illustrating an example electronic device in a network environment according to various embodiments.

### DETAILED DESCRIPTION

Hereinafter, various example embodiments of the disclosure will be described in greater detail with reference to the accompanying drawings. However, the disclosure may be implemented in different forms and is not limited to the example embodiments set forth herein. In addition, in the drawings, parts having nothing to do with the descriptions may be omitted for the clear description of the disclosure, and throughout the disclosure, the same or like reference numerals are used for the same or like elements.

The terms used in the disclosure are described as general terms currently used considering the functions mentioned in the disclosure, but may refer to various other terms according to the intent of those skilled in the art, precedent, the emergence of new technologies. Accordingly, the terms used in the disclosure should not be interpreted solely based on their names and should be interpreted based on the meanings of the terms and the whole context of the disclosure.

Such terms as “1st” and “2nd,” or “first” and “second” may be used to explain various components, but the components should not be limited by such terms. These terms may be used for the purpose of distinguishing one component from other components.

Throughout the disclosure, it is to be understood that if an element is referred to as “connected with/to” another element, it may refer, for example, to the element being “directly connected” with another element or may be “electrically connected” with another element via an intervening element therebetween. It will be further understood that when a certain portion is referred to as “including” a certain element, the certain portion does not exclude other components and may further include other components unless the context clearly indicates otherwise.

The phrase “in an embodiment” used in the disclosure does not necessarily indicate the same embodiment.

An embodiment of the disclosure may be represented by functional block configurations and various processing steps. Some or all of the functional blocks may be implemented by various numbers of hardware and/or software configurations that perform specific functions. For example, the functional blocks of the disclosure may be implemented by one or more microprocessors or may be implemented by circuit configurations for predetermined functions. In addition, for example, the functional blocks of the disclosure may be implemented by various programming or scripting languages. The functional blocks may be implemented by an algorithm that is executed in one or more processors. The disclosure may employ related-art technologies for electronic environment configuration, signal processing, and/or data processing. Such terms “mechanism”, “element”, “means”, and “configuration” may be broadly used and are not limited to mechanical and physical configurations.

In addition, connecting lines or connecting members among components shown in the drawings are only examples of functional connection and/or physical or circuitry connections. In an actual device, connections among components may be represented by a variety of alternative or additional functional connections, physical connections, or circuit connections.

Hereinafter, the disclosure will be described in greater detail with reference to the accompanying drawings.

According to an example embodiment of the disclosure, a device that provides a notification for an urgent call from a transmission device may include: a communication interface comprising communication circuitry; a memory configured to store instructions; and at least one processor, comprising processing circuitry, operatively connected with the communication interface and the memory and individually and/or collectively configured to execute the instructions, and, to cause the device to: receive a session initiation protocol (SIP) invite message for the urgent call generated at the transmission device from an SIP server; in response to the SIP invite message being received, identify that an urgent notification function of notifying a user of the urgent call based on the SIP invite message is supported by the device; and, in response to identifying that the urgent notification function is supported, acquire urgent notification support information indicating that the urgent notification function is supported; transmit an SIP response code as to the SIP invite message to the SIP server along with the urgent notification support information, and the transmitted SIP response code and the urgent notification support information may be provided to the transmission device from the SIP server, and, in response to identifying that the urgent notification function is supported, output an urgent notification notifying that the SIP invite message for the urgent call is received; receive an input (e.g., a user input) for connecting the urgent call, and may establish a session for the urgent call with the transmission device.

The SIP response code as to the SIP invite message may be a code of ‘180: Ringing’, and the urgent notification support information may be transmitted to the SIP server along with the code of ‘180: Ringing’ as a response to the SIP invite message.

The urgent notification support information provided along with the SIP response code may be used by the transmission device to identify whether the device supports the urgent notification.

Accordingly, when the device supports the urgent notification, the transmission device may effectively determine whether the device supports the urgent notification using the urgent notification support information provided along the SIP response code.

At least one processor, individually and/or collectively, may be configured to cause the device to: acquire a device list which is a target of the urgent notification in response to identifying that the urgent notification function is supported, and determine whether an identification value of the transmission device is included in the device; and based on the identification value of the transmission device being included in the device list, generate the urgent notification.

Accordingly, the device may identify an urgent call from the transmission device included in the device list, so that an unnecessary urgent call notification is not output.

At least one processor, individually and/or collectively, may be configured to cause the device to: transmit only the SIP response code as to the SIP invite message to the SIP server in response to identifying that the urgent notification function is not supported. The transmitted SIP response code may be provided to the transmission device from the SIP server.

Accordingly, when the device does not support the urgent notification, the transmission device may effectively determine whether the device supports the urgent notification by identifying that only the SIP response code is provided.

At least one processor, individually and/or collectively, may be configured to cause the device to: receive a text message notifying the urgent call from the transmission device based on only the SIP response code as to the SIP invite message being provided to the transmission device; a text message notifying the urgent call may be transmitted to the device by the transmission device in response to identifying by the transmission device that only the SIP response code is provided to the transmission device.

At least one processor, individually and/or collectively, may be configured to cause the device to: transmit a SIP response code for connecting the urgent call to the SIP server in response to an input (e.g., user input) for connecting the urgent call being received. In addition, the SIP response code for connecting the urgent call may be a code of ‘200: OK’.

At least one processor, individually and/or collectively, may be configured to cause the device to: identify a waiting time for the input for connecting the urgent call, and provide an urgent notification notifying that the urgent call is received to another device in response to the waiting time exceeding a designated threshold value.

In addition, the urgent notification provided to the another device may be output from the another device for a specified time before the session for the urgent call is established.

At least one processor, individually and/or collectively, may be configured request an internet of things (IoT) server which manages other devices to provide the urgent notification.

Accordingly, even when the device does not respond to the urgent call request, the device may provide the urgent notification to another device of the user, so that the notification of the urgent call may be effectively provided to the user.

According to an example embodiment of the disclosure, a method of a reception device for providing a notification for an urgent call may include: receiving, from an SIP server, an SIP invite message for the urgent call generated at a transmission device; in response to the SIP invite message being received, identifying that an urgent notification function of notifying a user of the urgent call based on the SIP invite message is supported by the reception device; and, in response to identifying that the urgent notification function is supported, acquiring urgent notification support information indicating that the urgent notification function is supported. In addition, the method may include: transmitting an SIP response code as to the SIP invite message to the SIP server along with the urgent notification support information, and the transmitted SIP response code and the urgent notification support information may be provided to the transmission device from the SIP server. The method may include, in response to identifying that the urgent notification function is supported, outputting an urgent notification notifying that the SIP invite message for the urgent call is received. The method may include: receiving an input for connecting the urgent call; and establishing a session for the urgent call with the transmission device.

The SIP response code as to the SIP invite message may be a code of ‘180: Ringing’, and the urgent notification support information may be transmitted to the SIP server along with the code of ‘180: Ringing’ as a response to the SIP invite message.

The urgent notification support information provided along with the SIP response code may be used by the transmission device to identify whether the reception device supports the urgent notification.

The method may include, in response to identifying that the urgent notification function is supported: acquiring a device list which is a target of the urgent notification; and determining whether an identification value of the transmission device is included in the device list. The method may include, based on the identification value of the transmission device being included in the device list, generating the urgent notification.

In response to identifying that the urgent notification function is not supported, the method may transmit only the SIP response code as to the SIP invite message to the SIP server, and the transmitted SIP response code may be provided to the transmission device from the SIP server.

The method may further include, based on only the SIP response code as to the SIP invite message being provided to the transmission device, receiving a text message notifying the urgent call from the transmission device. The text message notifying the urgent call may be transmitted to the reception device by the transmission device in response to it being identified by the transmission device that only the SIP response code is provided to the transmission device.

The method may further include transmitting a SIP response code for connecting the urgent call to the SIP server in response to an input for connecting the urgent call being received. In addition, the SIP response code for connecting the urgent call may be a code of ‘200: OK’.

The method may further include: identifying a waiting time for the input for connecting the urgent call; and providing an urgent notification notifying that the urgent call is received to another device in response to the waiting time exceeding a designated threshold value.

In the method, the urgent notification provided to the another device may be output from the another device for a predetermined time before the session for the urgent call is established.

According to an example embodiment of the disclosure, a non-transitory computer-readable recording medium may have a program recorded thereon which, when executed by at least one processor, comprising processing circuitry, individually and/or collectively, of an electronic device, cause the electronic device to perform a method of providing a notification for an urgent call, wherein the method may include: receiving, from an SIP server, an SIP invite message for the urgent call generated at a transmission device; in response to the SIP invite message being received, identifying that an urgent notification function of notifying a user of the urgent call based on the SIP invite message is supported by the reception device; in response to identifying that the urgent notification function is supported, acquiring urgent notification support information indicating that the urgent notification function is supported; transmitting an SIP response code as to the SIP invite message to the SIP server along with the urgent notification support information, the transmitted SIP response code and the urgent notification support information being provided to the transmission device from the SIP server; in response to identifying that the urgent notification function is supported, outputting an urgent notification notifying that the SIP invite message for the urgent call is received; receiving an input for connecting the urgent call; and establishing a session for the urgent call with the transmission device.

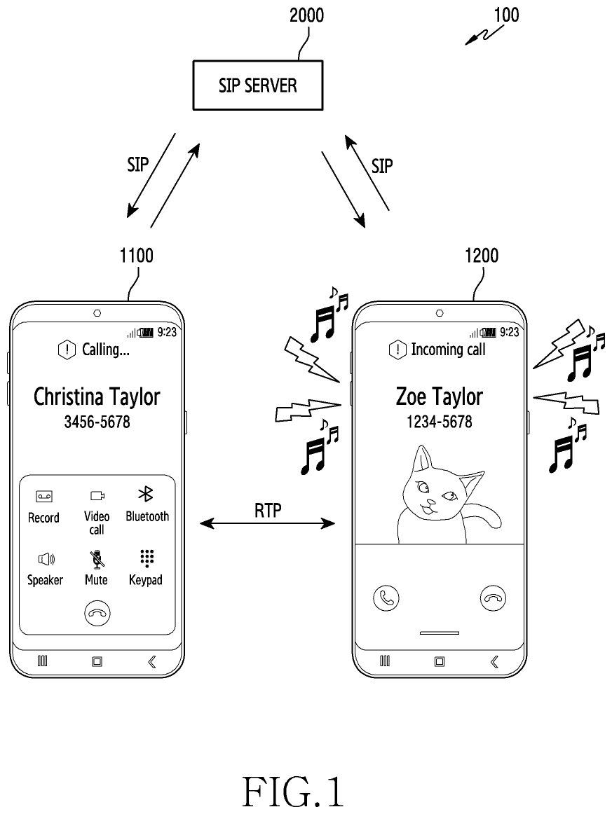

FIG. 1 is a diagram illustrating an urgent call notification system that enables a reception device to notify a user of an urgent call according to various embodiments.

Referring to FIG. 1, the urgent call notification system 100 may include a transmission device 1100, a reception device 1200, and a session initiation protocol (SIP) server 2000. The transmission device 1100, the reception device 1200, and the SIP server 2000 may exchange data for an urgent call with one another via a SIP protocol. The transmission device may be a mobile originated (MO) device and the reception device may be a mobile terminated (MT) device.

The transmission device 1100 may request an urgent call to the reception device 1200 via the SIP server 2000. When a function of notifying an urgent call from the transmission device 100 is supported by the reception device 1200, the reception device 1200 may output an urgent notification notifying reception of the urgent call. When the function of notifying the urgent call from the transmission device 1100 is not supported by the reception device 1200, the reception device 1200 may receive a text message separately transmitted from the transmission device 1100, and may output the received text message, thereby notifying a user of reception of the urgent call.

The transmission device 1100 may generate a SIP invite message for the urgent call, and may provide the SIP invite message to the reception device 1200 via the SIP server 2000. In response to the SIP invite message being received, the reception device 1200 may identify whether the urgent notification function to notify the user of the urgent call is supported by the reception device 1200, and may provide urgent notification support information notifying that the urgent notification function is supported by the reception device 1200 to the transmission device 1100 via the SIP server 2000 along with a SIP response code. In response to the urgent notification support information being provided to the transmission device 1100 along with the SIP response code, the transmission device 1100 may identify whether the reception device 1200 supports the urgent notification function. When the urgent notification function is not supported by the reception device 1200, the transmission device 1100 may generate a separate text message for notifying the urgent call and may transmit the text message to the reception device 1200.

When the urgent notification function is supported by the reception device 1200, the reception device 1200 may generate and output an urgent notification notifying that the urgent is received.

Regardless of whether the function of notifying the urgent call generated by the transmission device 1100 is supported by the reception device 1200, the reception device 1200 may output the urgent notification or the text message, and accordingly, the reception device 1200 may effectively notify the user that the urgent call is received.

The transmission device 1100 and the reception device 1200 may include, for example, a portable communication device (for example, a smartphone), a computer device, a portable multimedia device, a portable medical device, a camera, a wearable device or a home appliance. The transmission device 1100 and the reception device 1200 according to an embodiment of the disclosure are not limited to the above-mentioned devices.

In the disclosure, it is illustrated that the transmission device 1100 requests a phone call and the reception device 1200 accepts a phone call for the convenience of explanation, but this should not be considered as limiting. The transmission device 1100 may perform the function of accepting a phone call, and the reception device 1200 may perform the function of requesting a phone call.

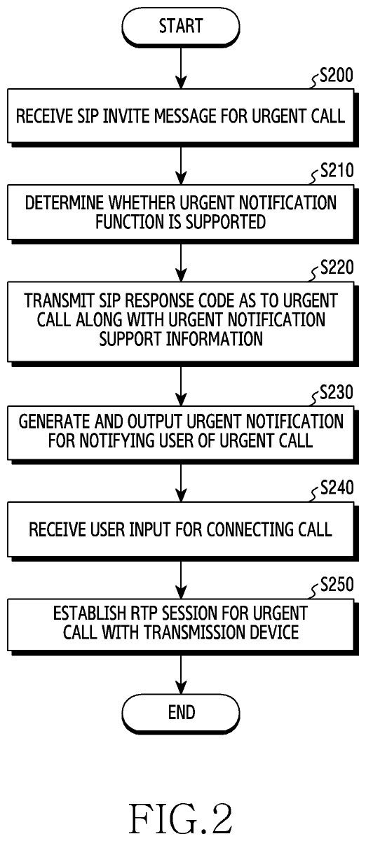

FIG. 2 is a flowchart illustrating an example method of a reception device for providing a notification for an urgent call according to various embodiments.

In operation S200, the reception device 1200 may receive a SIP invite message for an urgent call provided from the transmission device 1100. The transmission device 1100 may provide the SIP invite message for the urgent call to the reception device 1200 via the SIP server 2000 based on a user input for the urgent call of the reception device 1200. The reception device 1200 may receive the SIP invite message for the urgent call from the SIP server 2000. The SIP invite message may include information notifying that the call is urgent and an identification value of the transmission device 1100. The SIP invite message may include, for example, a high priority level and a phone number of the transmission device 1100, but is not limited thereto. The SIP invite message may include, for example, an emergency URI and a phone number of the transmission device 1100.

In operation S210, the reception device 1200 may determine whether the reception device 1200 supports an urgent notification function of notifying an urgent call. The reception device 1200 may determine whether the function of notifying the user of the urgent call is supported by the reception device 1200 in response to the SIP invite message being received. The reception device 1200 may identify the information indicating that the call is urgent, which is included in the SIP invite message, and may determine whether the reception device 1200 supports the function of notifying the user of the urgent call in relation to the identified information.

In operation S220, the reception device 1200 may transmit a SIP response code as to the urgent call along with urgent notification support information. When the reception device 1200 supports the function of notifying the user of the urgent call, the reception device 1200 may provide the urgent notification support information indicating whether the reception device 1200 supports the function of notifying the user of the urgent call to the transmission device 1100 along with the SIP response code. For example, the reception device 1200 may provide a flag indicating whether the reception device 1200 supports the function of notifying the user of the urgent call to the transmission device 1100 along with the SIP response code. The SIP response code may be, for example, a code of ‘180: ringing’, and may be provided to the transmission device 110 via the SIP server 2000.

When the reception device 1200 does not support the function of notifying the user of the urgent call, the reception device 1200 may provide only the SIP response code to the transmission device 1100.

In operation S230, the reception device 1200 may generate and output an urgent notification for notifying the user of the urgent call. The urgent notification for notifying the user of the urgent call may include, for example, at least one of a text, an image or a sound. The urgent notification may be output from the reception device 1200 while at least one of a sound, a graphical user interface (GUI), or a vibration for notifying reception of the call is being output. For example, the urgent notification may be output from the reception device 1200 independently from the sound, the GUI and the vibration for notifying the reception of the call. For example, the urgent notification may be output from the reception device 1200 as a part of the sound, the GUI, and the vibration for notifying the reception of the call.

In operation S240, the reception device 1200 may receive an input (e.g., a user input) for connecting the urgent call. The reception device 1200 may display an object for connecting the urgent call on a display, and may receive a user input of selecting the object for connecting the urgent call.

In response to the user input for connecting the urgent call being received, the reception device 1200 may provide a SIP code for connecting the urgent call to the transmission device 1100. The reception device 1200 may provide a code of ‘200 OK’ to the transmission device via the SIP server 2000.

In operation S250, the reception device 1200 may establish a realtime transport protocol (RTP) session for the urgent call with the transmission device 1100. The transmission device 1100 may identify the SIP code provided from the reception device 1200, thereby identifying that an urgent call connection is requested by the reception device 1200. The transmission device 1100 may identify the SIP code for connecting the urgent call, such that the RTP session for the urgent call is established between the transmission device 1100 and the reception device 1200.

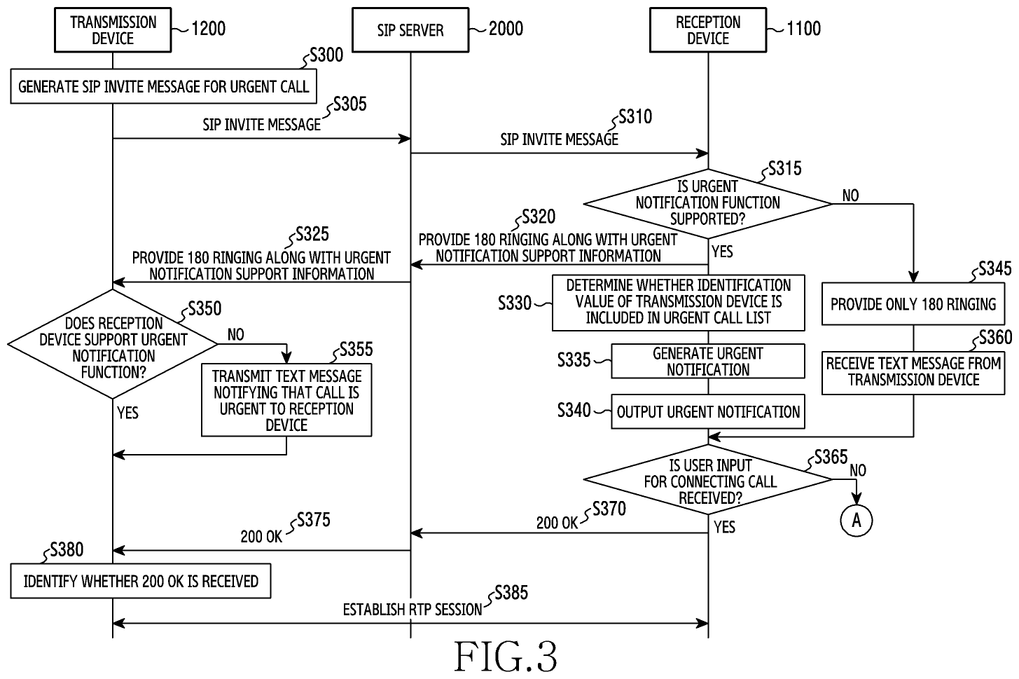

FIG. 3 is a flowchart illustrating an example call connection method of a transmission device, a reception device, and a SIP server that enables a notification for an urgent call to be output at the reception device according to various embodiments.

In operation 300, the transmission device 1100 may generate a SIP invite message for an urgent call. The transmission device 1100 may receive a user input for an urgent call with the reception device 1200, and may generate a SIP invite message for requesting an urgent call with the reception device 1200. For example, the transmission device 1100 may display an object for the urgent call on a GUI for sending a call, and may receive a user input of selecting the object for the urgent call. In response to the user input for the urgent call being received, the transmission device 1100 may generate a SIP invite message including information indicating that the message is a message for requesting the urgent call. The SIP invite message for requesting the urgent call may include, for example, an emergency URL, but is not limited thereto.

The transmission device 1100 may generate a SIP invite message for an urgent call in a normal call mode. The normal call mode may be a call mode in which a call is typically provided between devices. For example, the normal call mode may be a mode in which a phone call is made according to a normal user input while an execution screen of a phone application is being displayed in an unlocked state of a device.

The transmission device 1100 may generate a SIP invite message for an urgent call in an urgent call mode. The urgent call mode may be a call mode in which the user can make a call to a specific device urgently with a minimal user input when the user encounters an emergency situation or danger. For example, in the urgent call mode, a device may make a call to a specific device urgently while being in a locked state.

In operation S305, the transmission device 1100 may provide the SIP invite message to the SIP server 2000, and in operation S310, the SIP server 2000 may provide the SIP invite message to the reception device 1200.

In operation S315, the reception device 1200 may determine whether the reception device 1200 supports an urgent notification function. The reception device 1200 may identify information indicating that the call is urgent, which is included in the SIP invite message, and may determine whether the reception device 1200 supports the function of notifying the user of the urgent call in relation to the identified information.

When the reception device 1200 supports the urgent notification function related to the SIP invite message provided from the transmission device 1100, the reception device 1200 may identify the information indicating that the call is urgent, which is included in the SIP invite message. In response to the information indicating that the call is urgent being identified, the reception device 1200 may determine that the reception device 1200 supports the urgent notification function. For example, the information indicating that the call is urgent, which is included in the SIP invite message, may be data of a pre-set format, and, when the reception device 1200 supports the urgent notification function related to the SIP invite message provided from the transmission device 1100, the reception device 1200 may interpret the data of the pre-set format.

When the reception device 1200 does not support the urgent notification function related to the SIP invite message provided from the transmission device 1100, the reception device 1200 may disregard the information indicating that the call is urgent, which is included in the SIP invite message. In response to the information indicating that the call is urgent being disregarded, the reception device 1200 may determine that the reception device 1200 does not support the urgent notification function. For example, the information indicating that the call is urgent, which is included in the SIP invite message, may be data of a pre-set format, and, when the reception device 1200 does not support the urgent notification function related to the SIP invite message provided from the transmission device 1100, the reception device 1200 may not interpret the data of the pre-set format.

In response to it being determined that the reception device 1200 supports the urgent notification function as a result of determining in operation S315, the reception device 1200 may provide urgent notification support information to the SIP server 2000 along with a SIP response code in operation S320, and the SIP server 2000 may provide the urgent notification support information to the transmission device 1100 along with the SIP response code in operation S325. For example, the urgent notification support information may be a flag indicating whether the reception device supports the function of notifying the user of the urgent call.

The urgent notification support function may be information indicating that the reception device 1200 supports the function of notifying the user of the urgent call. The urgent notification support information may be generated by the reception device 1200 in response to it being determined that the reception device 1200 supports the urgent notification function. The SIP response code may be a code that is provided as a response to the SIP invite message. The SIP response code may be, for example, a code of ‘180 ringing’.

In operation S330, the reception device 1200 may determine whether an identification value of the transmission device 1100 is included in an urgent call list. The urgent call list may be a list of devices which are targets of the urgent notification related to the urgent call. The urgent call list may include, for example, a phone number of a device, a SSID, a model name and a name of a user of a device, a service ID, but is not limited thereto. For example, the reception device 1200 may compare the phone number of the transmission device 1100, which transmits the SIP invite message for the urgent call, with phone numbers of devices in the urgent call list. According to an embodiment, an urgent notification level corresponding to a device may be set by devices in the urgent call list. When an urgent notification level corresponding to a device is set, the reception device 1200 may identify an urgent notification level corresponding to the transmission device 1100.

In operation S335, the reception device 1200 may generate an urgent notification for connecting the urgent call. When the identification value of the transmission device 1100 is included in the urgent call list, the reception device 1200 may generate an urgent notification for connecting the urgent call. The urgent notification for notifying the user of the urgent call may include, for example, at least one of a text, an image or a sound. According to an embodiment, an urgent notification level corresponding to a device may be set by devices in the urgent call list. When an urgent notification level corresponding to a device is set, the reception device 1200 may generate the urgent notification considering the urgent notification level corresponding to the transmission device 1100.

In operation S340, the reception device 1200 may output the urgent notification for connecting the urgent call. The reception device 1200 may output the urgent notification in the middle of outputting at least one of a sound, a GUI, or a vibration notifying call reception at the reception device 1200. For example, the reception device 1200 may output the urgent notification independently from the sound, GUI, and vibration notifying call reception. Alternatively, the reception device 1200 may output the urgent notification as a part of the sound, GUI, and vibration notifying call reception.

In response to it being determined that the reception device 1200 does not support the urgent notification function as a result of determining in operation S315, the reception device 1200 may provide only the SIP response code to the SIP server 2000 as a response to the urgent call in operation S345. The reception device 1200 may provide only the SIP response code without the urgent notification support information to the SIP server 2000 as a response to the urgent call. The reception device 1200 may provide only the SIP response code without the urgent notification support information to the SIP server 2000 as a response to the urgent call. The SIP response code provided to the SIP server 2000 may be provided to the transmission device 1100 from the SIP server 2000.

In operation S350, the transmission device 1100 may determine whether the reception device 1200 supports the urgent notification function. When the SIP response code is received from the reception device 1200 along with the urgent notification support information, the transmission device 1100 may determine that the reception device 1200 supports the urgent notification function by identifying the urgent notification support information.

When the SIP response code is received from the reception device 1200 without the urgent notification support information, the transmission device 1100 may not identify the urgent notification support information, and accordingly, the transmission device 1100 may determine that the reception device 1200 does not support the urgent notification function.

In response to it being determined that the reception device 1200 does not support the urgent notification function as a result of determining in operation S350, the transmission device 1100 may transmit a text message indicating that the call is urgent to the reception device 1200 in operation S355. The transmission device 1100 may pre-store the urgent text message notifying that the call is urgent in a memory. The transmission device 1100 may extract the urgent text message from the memory, and may transmit the extracted urgent text message to the reception device 1200 through a SMS service or an MMS service.

When a plurality of urgent text messages notifying that the call is urgent are stored in the memory, the transmission device 1100 may select an urgent text message to transmit to the reception device 1200 among the plurality of urgent text messages. For example, the plurality of urgent text messages may be pre-set by devices, but are not limited thereto.

The transmission device 1100 may display a GUI to generate or edit the urgent text message notifying that the call is urgent on a display. The transmission device 1100 may generate or edit the urgent text message notifying that the call is urgent, based on a user input via the GUI.

In operation S360, the reception device 1200 may receive a text message from the transmission device 1100. The reception device 1200 may display the received text message on the display of the reception device 1200. The text message notifying the urgent call, received from the transmission device 1100, may be the urgent text message, and the content of the text message may be forced to be displayed on the screen of the reception device 1200. For example, while displaying a GUI indicting that the call request is received from the transmission device 1100 on the display of the reception device 1200, the reception device 1200 may be forced to display the content of the urgent text message on the GUI indicating that the call request is received from the transmission device 1100. For example, the content of the urgent text message may overlap the GUI indicating that the call request is received.

In operation S365, the reception device 1200 may determine whether an input (e.g., a user input) for connecting the call is received. The reception device 1200 may receive a user input for connecting the call with the transmission device 1100 via the GUI indicating that the call request is received from the transmission device 1100.

When it is determined that the user input for connecting the call is received as a result of determining in operation S365, the reception device 1200 may transmit a SIP response code (for example, 200 OK) to the SIP server 2000 in operation S370, and the SIP server 2000 may transmit the SIP response code (for example, 200 OK) to the transmission device 1100 in operation S375. The SIP response code (for example, 200 OK) may be a code for requesting connection of the urgent call.

In response to it being determined that the reception device 1200 supports the urgent notification function as a result of determining in operation S350, the transmission device 1100 may perform operation S380.

In operation S380, the transmission device 1100 may identify whether the SIP response code (for example, 200 OK) requesting connection of the urgent call is received. In response to it being determined that the reception device 1200 supports the urgent notification function, the transmission device 1100 may wait for reception of the SIP response code (for example, 200 OK) requesting connection of the urgent call.

In operation S385, the transmission device 1100 may establish a realtime transport protocol (RTP) session for the urgent call with the reception device 1200. In response to the RTP session being established, the transmission device 1100 may perform the urgent call with the reception device 1200.

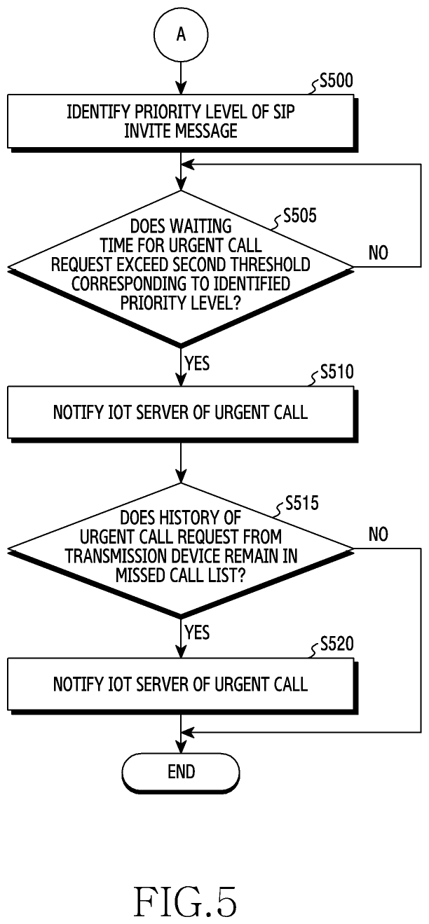

When it is determined that the user input for connecting the call is not received for a first threshold as a result of determining in operation S365, the reception device 1200 may perform operations shown in FIGS. 5, 6 and 7 (which may be referred to as FIGS. 5 to 7), which will be described in greater detail below.

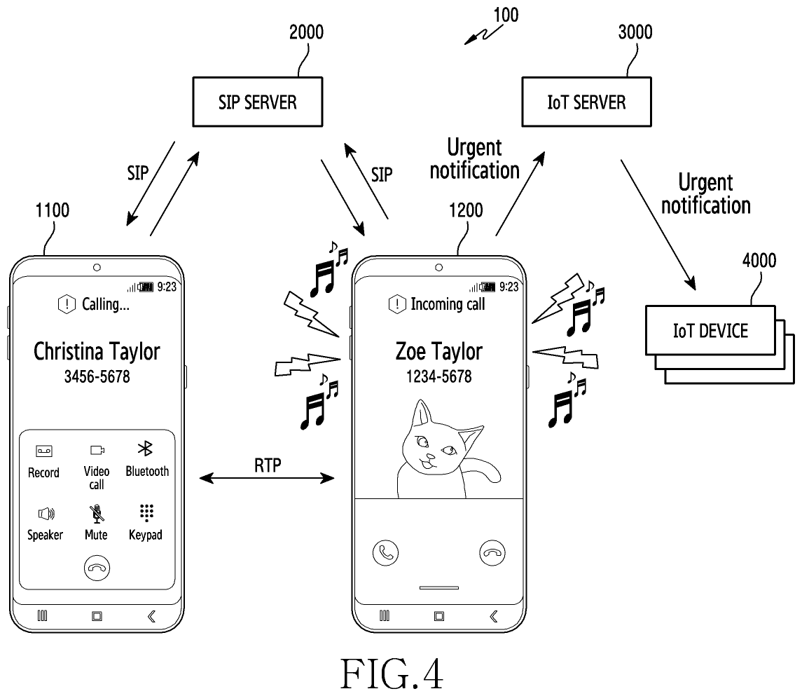

FIG. 4 is a diagram illustrating an urgent call notification system that enables a reception device to notify an IoT device of an urgent call via an IoT server according to various embodiments.

Referring to FIG. 4, the reception device 1200 may provide an urgent notification notifying that an urgent call is requested from the transmission device 110 to an Internet of Things (IoT) device 4000 via an IoT server 3000. The IoT server 3000 may be a server that manages the IoT device 4000 of the user of the reception device 1200, and the IoT device 4000 may be a device that interlocks with the reception device 1200 to provide an IoT service.

The IoT device 4000 may include, for example, a portable communication device (for example, a smartphone), a computer device, a portable multimedia device, a portable medical device, a camera, a wearable device, or a home appliance. The IoT device 4000 according to an embodiment of the disclosure is not limited to the above-mentioned devices.

FIG. 5 is a flowchart illustrating an example method of a reception device for providing an urgent notification to an IoT device via an IoT server according to various embodiments.

In operation S500, the reception device 1200 may identify a priority level of a SIP invite message. When it is determined that the user input for connecting the call is not received for the first threshold as a result of determining in operation S365, the reception device 1200 may identify a priority level included in the SIP invite message. The reception device 1200 may identify the priority of the urgent call by identifying the priority level.

In operation S505, the reception device 1200 may determine whether a waiting time for the urgent call request exceeds a second threshold corresponding to the identified priority level. The waiting time for the urgent call request may be an amount of time that the reception device 1200 waits to receive the user input for requesting the urgent call after receiving the SIP invite message for the urgent call.

The second threshold may be set differently depending on the priority level. For example, the second threshold corresponding to a high priority level may have a smaller value than the second threshold corresponding to a low priority level. For example, when the priority level is high and the urgency of the urgent call is high, the second threshold may be set to a relatively low value. For example, when the priority level is low and the urgency of the urgent call is low, the second threshold may be set to a relatively high value.

When it is determined that the waiting time for the urgent call request does not exceed the second threshold as a result of determining in operation S505, the reception device 1200 may perform operation S505 again.

When it is determined that the waiting time for the urgent call request exceeds the second threshold as a result of determining in operation S505, the reception device 1200 may notify the IoT server 3000 of the urgent call in operation S510. The reception device 1200 may transmit the urgent notification information notifying that the urgent call is received to the IoT server 3000. The urgent notification information may include, for example, a message indicating that the urgent call is received, identification information of the transmission device 1100, identification information of the reception device 1200, a priority level of the urgent call, and a service ID of an IoT service, but is not limited thereto.

The IoT server 3000 may identify at least one IoT device 4000 registered at the IoT server 3000 by the user of the reception device 1200, based on the identification information of the reception device 1200 and/or the service ID of the IoT service, which are included in the urgent notification information received from the reception device 1200. In addition, the IoT server 3000 may notify the identified IoT device 4000 of the urgent call, based on the message indicating that the urgent call is received, the identification information of the transmission device 1100, the identification information of the reception device 1200 and/or the priority level of the urgent call, which are included in the urgent notification information received from the reception device 1200.

In operation S515, the reception device 1200 may determine whether the history of the urgent call request from the transmission device 1100 remains in a missed call list. When the user input for connecting the urgent call from the transmission device 1100 is not received and the urgent call from the transmission device 1100 is missed, the history of the urgent call request from the transmission device 1100 may be recorded on the missed call list. The missed call list may be a list on which the history of the urgent call request is recorded.

After a designated time is elapsed after the urgent call from the transmission device 1100 is missed, the reception device 1200 may determine whether the history of the urgent all request from the transmission device 1100 remains in the missed call list. The reception device 1200 may determine whether the history of the urgent call request from the transmission device 1100 remains in the missed call list according to a designated period after the urgent call from the transmission device 1100 is missed.

When it is determined that the history of the urgent call request from the transmission device 1100 remains in the missed call list as a result of determining in operation S515, the reception device 1200 may notify the IoT server 3000 of the urgent call in operation S520. The reception device 1200 may transmit the urgent notification information notifying that the urgent call is received to the IoT server 3000. The urgent notification information may include, for example, a message indicating that the urgent call is received, identification information of the transmission device 1100, identification information of the reception device 1200, a priority level of the urgent call, a service ID of an IoT service, but is not limited thereto.

The IoT server 3000 may identify at least one IoT device 4000 registered at the IoT server 3000 by the user of the reception device 1200, based on the identification information of the reception device 1200 and/or the service ID of the IoT service included in the urgent notification information received from the reception device 1200. The IoT server 3000 may select the IoT device 4000 that is used by the user or located in the proximity of the user among the identified IoT devices 4000. To achieve this, the IoT server 3000 may receive information indicating a current execution state and information on a peripheral device communicably connected from the IoT device 4000.

The IoT server 3000 may notify the IoT device 4000 of the urgent call, based on the message indicating that the urgent call is received, the identification information of the transmission device 1100, the identification information of the reception device 1200 and/or the priority level of the urgent call, which are included in the urgent notification information received from the reception device 1200.

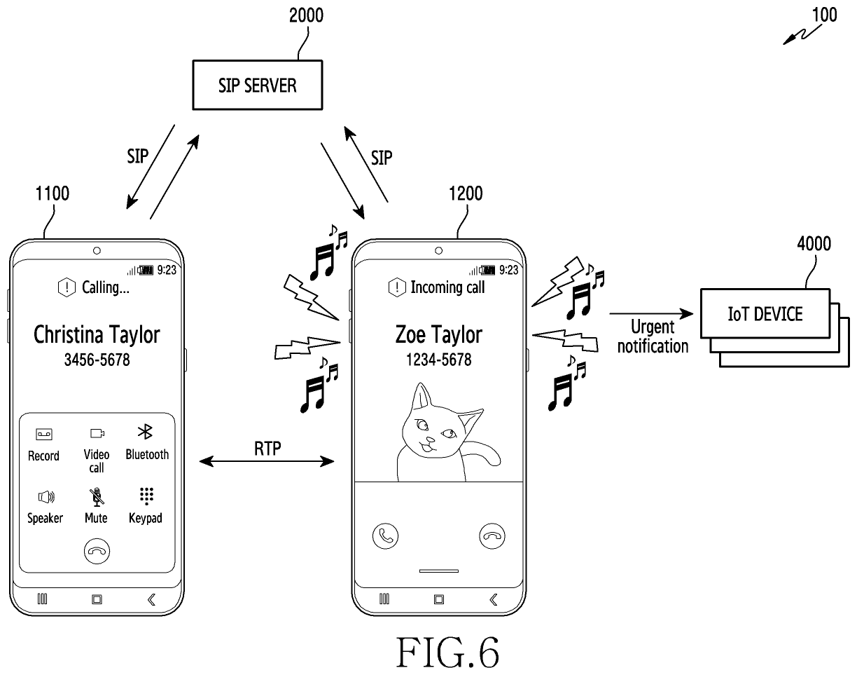

FIG. 6 is a is a diagram illustrating an urgent call notification system that enables a reception device to notify an IoT device of an urgent call according to various embodiments.

Referring to FIG. 6, the reception device 1200 may provide an urgent notification notifying that an urgent call is requested from the transmission device 1100 to the IoT device 4000. The reception device 1200 may identify the communicative IoT device 4000, and may transmit the urgent notification notifying that the urgent call is requested to the identified IoT device 4000. The IoT device 400 which will receive the urgent notification may be pre-set by the user, but is not limited thereto.

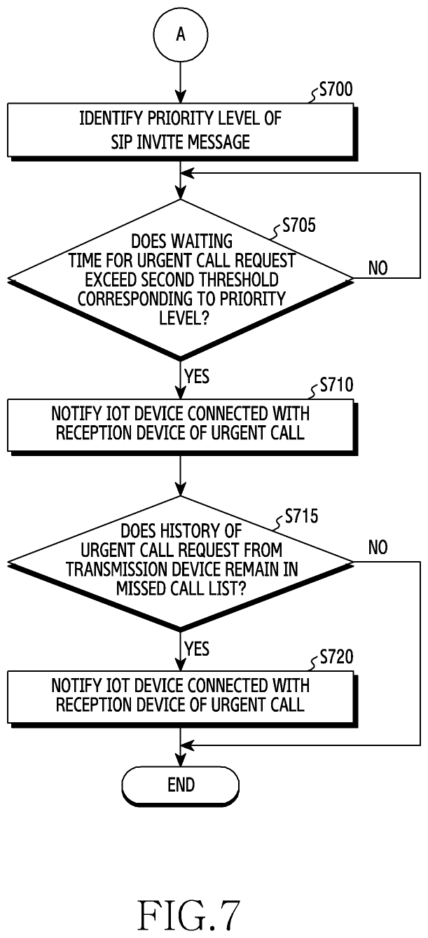

FIG. 7 is a flowchart illustrating an example method of a reception device for providing an urgent notification to an IoT device according to various embodiments.

Operations S700, S705, and S715 of FIG. 7 correspond to operations S550, S505 and S515 of FIG. 5, and repeated descriptions of operations S700, S705, and S715 may not be provided here for the convenience of explanation.

When it is determined that the waiting time for the urgent call request exceeds the second threshold as a result of determining in operation S705, the reception device 1200 may notify the IoT device 4000 of the urgent call in operation S710. The reception device 1200 may transmit the urgent notification information notifying that the urgent call is received to the IoT device 4000. The urgent notification information may include, for example, a message indicating that the urgent call is received, identification information of the transmission device 1100, identification information of the reception device 1200, and a priority level of the urgent call, but is not limited thereto.

The reception device 1200 may identify at least one IoT device 4000 registered by the user. The reception device 1200 may select the IoT device 4000 that is used by the user or is located in the proximity of the reception device 1200 among the identified IoT devices 4000. To achieve this, the reception device 1200 may receive information indicating a current execution state and information on a communicably connected peripheral device from the IoT device 4000.

When it is determined that the history of the urgent call request from the transmission device 1100 remains in the missed call list as a result of determining in operation S715, the reception device 1200 may notify the IoT device 4000 of the urgent call in operation S720. The reception device 1200 may transmit the urgent notification information notifying that the urgent call is received to the IoT device 4000. The urgent notification information may include, for example, a message indicating that the urgent call is received, identification information of the transmission device 1100, identification information of the reception device 1200, and a priority level of the urgent call, but is not limited thereto.

The reception device 1200 may identify at least one IoT device 4000 registered by the user. The reception device 1200 may select the IoT device 4000 that is used by the user or is located in the proximity of the reception device 1200 among the identified IoT devices 4000. To achieve this, the reception device 1200 may receive information indicating a current execution state and information on a communicably connected peripheral device from the IoT device 4000.

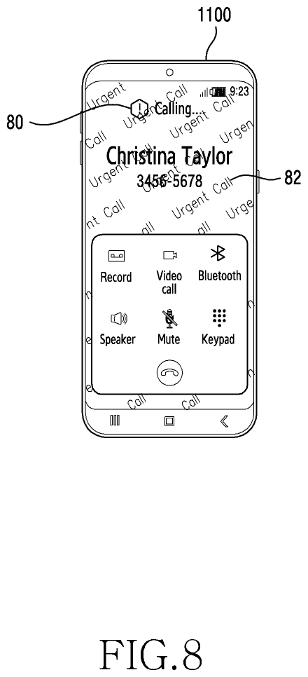

FIG. 8 is a diagram illustrating a screen of a transmission device when the transmission device transmits a call for an urgent notification according to various embodiments.

Referring to FIG. 8, when the user of the transmission device 1100 encounters an emergency situation or danger, the transmission device 1100 may transmit a call in an urgent call mode based on a user input.

When the transmission device 1100 transmits the urgent call, an icon 80 indicating that the transmission device 110 transmits the urgent call may be displayed on the screen of the transmission device 1100. In addition, when the transmission device 1100 transmits the urgent call, a text 82 indicating that the urgent call is being transmitted may be repeatedly displayed on the screen of the transmission device 1100. The text 82 indicating that the urgent call is being transmitted may be, for example, “Urgent Call”, but is not limited thereto.

When the transmission device 1100 transmits the urgent call, the transmission device 1100 may generate a SIP invite message for requesting the urgent call, and may provide the generated SIP invite message to the reception device 1200 via the SIP server 2000.

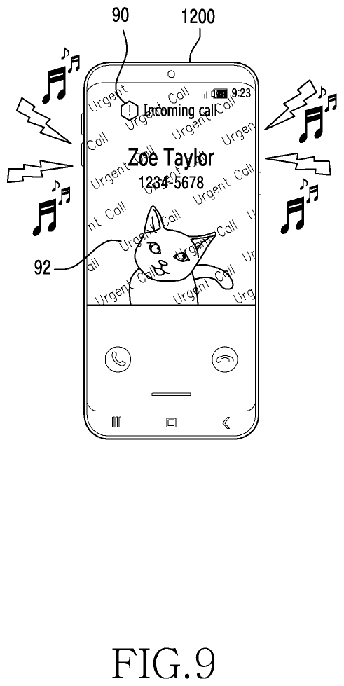

FIG. 9 is a diagram illustrating a screen of a reception device when the reception device supporting an urgent notification function receives an urgent call according to various embodiments.

The reception device 1200 may receive the SIP invite message for the urgent call, which is provided from the transmission device 1100, and may output a notification for notifying the user that the urgent call is received. When the reception device 1200 supports the urgent notification function, the reception device 1200 may interpret the SIP invite message for the urgent call, which is provided from the transmission device 1100, and may identify that the urgent call is received in response to interpretation of the SIP invite message. For example, the reception device 1200 may identify the SIP invite message and may display an icon 90 for notifying that the urgent call is received on the screen of the reception device 1200. For example, the reception device 1200 may repeatedly display a text 92 indicating that the urgent call is received on the screen. The text 92 indicating that the urgent call is received may be, for example, “Urgent Call”, but is not limited thereto. For example, the reception device 1200 may output a pre-set sound for notifying that the urgent call is received. In this case, the type and volume of the pre-set sound may be pre-set by the user.

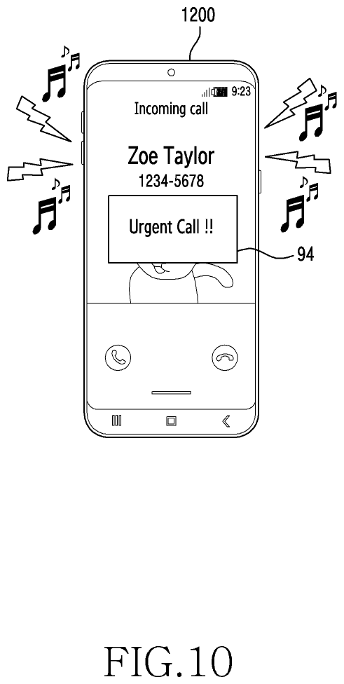

FIG. 10 is a diagram illustrating a screen of a reception device when the reception device that does not support the urgent notification function receives the urgent call according to various embodiments.

When the reception device 1200 does not support the urgent notification function, the reception device 1200 may receive the SIP invite message for the urgent call, which is provided from the transmission device 1100, but may not interpret the received SIP invite message as indicating the urgent call. In this case, the reception device 1200 may output a telephone ring which is output when a normal call is received. In response to the reception device 1200 failing to identify the SIP invite message for the urgent call, the reception device 1200 may separately receive a text message notifying the urgent call, provided from the transmission device 1100. When the text message notifying the urgent call is received, the reception device 1200 may display the text message on the screen of the reception device 1200 in the middle of outputting the telephone ring notifying that the urgent call is received. The text message 94 notifying the urgent call may be, for example, “Urgent Call !!”, but is not limited thereto.

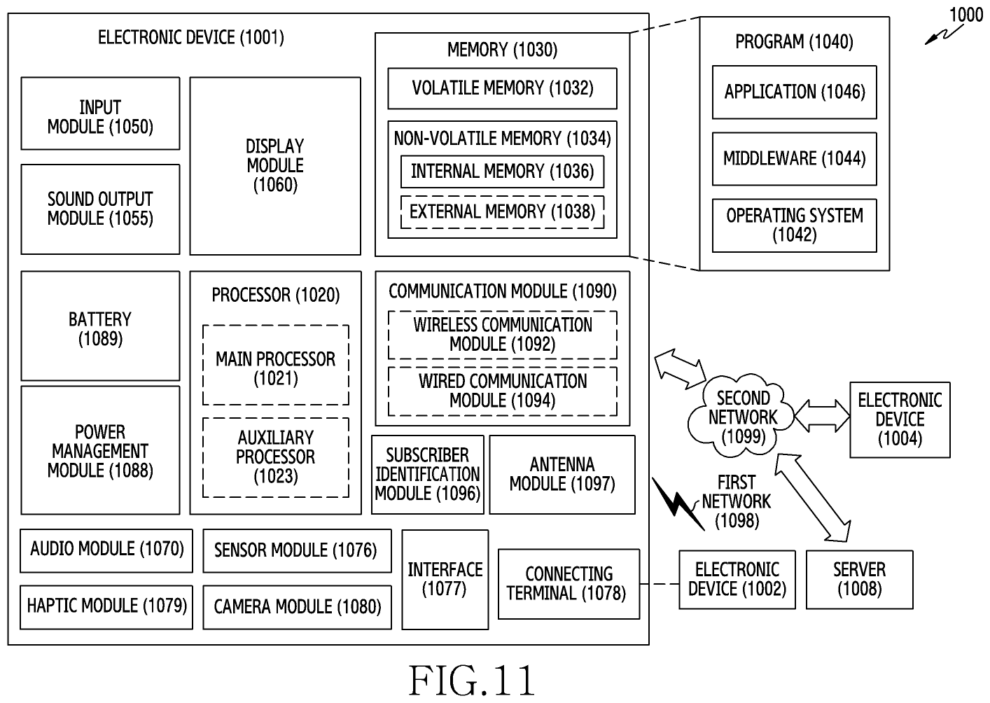

FIG. 11 is a block diagram illustrating an example electronic device 1001 in a network environment 1000 according to various embodiments.

Referring to FIG. 11, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In various embodiments, at least one of the components (e.g., the connecting terminal 1078) may be omitted from the electronic device 1001, or one or more other components may be added in the electronic device 1001. In various embodiments, some of the components (e.g., the sensor module 1076, the camera module 1080, or the antenna module 1097) may be implemented as a single component (e.g., the display module 1060).

The processor 1020 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element including a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In an embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

The electronic device 1001 of FIG. 11 may be the transmission device 1100 or the reception device 1200, and the server 1008 may be the SIP server 2000.

According to an embodiment, when the electronic device 1001 of FIG. 11 may be the transmission device 1100, the electronic device 1001 may generate a SIP invite message for an urgent all. The electronic device 1001 may receive a user input for the urgent call with the reception device 1200, and may generate the SIP invite message for requesting the urgent call with the reception device 1200. For example, the electronic device 1001 may display an object for the urgent call on a GUI for transmitting a call, and may receive a user input of selecting the object for the urgent call. In response to the user input for the urgent call being received, the electronic device 1001 may generate the SIP invite message including information indicating that the SIP invite message is a message requesting the urgent call. The SIP invite message for requesting the urgent call may include, for example, an emergency URL, but is not limited thereto.

The electronic device 1001 may generate the SIP invite message for the urgent call in a normal call mode. The normal call mode may be a call mode in which a call is typically provided between devices. For example, the normal call mode may be a mode in which a phone call is made according to a normal user input while an execution screen of a phone application is being displayed in an unlocked state of a device.

The electronic device 1001 may generate the SIP invite message for the urgent call in an urgent call mode. The urgent call mode may be a call mode in which the user can make a call to a specific device urgently with a minimal user input when the user encounters an emergency situation or danger. For example, in the urgent call mode, a device may make a call to a specific device urgently while being in a locked state.

The electronic device 1001 may provide the SIP invite message to the SIP server 2000, and the SIP server 2000 may provide the SIP invite message to the reception device 1200. In response to it being determined that the reception device 1200 receiving the SIP invite message supports the urgent notification function, the reception device 1200 may provide urgent notification support information to the SIP server 2000 along with a SIP response code, and the SIP server 2000 may provide the SIP response code to the electronic device 1001 along with the urgent notification support information. The urgent notification support information may be information indicating that the reception device 1200 supports the function of notifying the user of the urgent call. The urgent notification support information may be generated by the reception device 1200 in response to it being determined that the reception device 1200 supports the urgent notification function. The SIP response code may be a code that is provided as a response to the SIP invite message. The SIP response code may be, for example, a code of ‘180 ringing’.

The electronic device 1001 may determine whether the reception device 1200 supports the urgent notification function. When the electronic device 1001 receives the SIP response code from the reception device 1200 along with the urgent notification support information, the electronic device 1001 may determine that the reception device 1200 supports the urgent notification function by identifying the urgent notification support information.

When the electronic device 1001 receives the SIP response code without the urgent notification support information from the reception device 1200, the electronic device 1001 may not identify the urgent notification support information, and accordingly, the electronic device 1001 may determine that the reception device 1200 does not support the urgent notification function.

When it is determined that the reception device 1200 does not support the urgent notification function, the electronic device 1001 may transmit a text message notifying that the call is urgent to the reception device 1200. The electronic device 1001 may pre-store an urgent text message notifying that the call is urgent in the memory 1030. The electronic device 1001 may extract the urgent text message from the memory 1030, and may transmit the extracted urgent text message to the reception device 1200 via a SMS service or an MMS service.

When a plurality of urgent text messages notifying that the call is urgent are stored in the memory 1030, the electronic device 1001 may select an urgent text message to transmit to the reception device 1200 among the plurality of urgent text messages. For example, the plurality of urgent text messages may be pre-set by devices, but are not limited thereto.

The electronic device 1001 may display a GUI to generate or edit the urgent text message notifying that the call is urgent on the display. The electronic device 1001 may generate or edit the urgent text message notifying that the call is urgent, based on a user input via the GUI.

When a user input for connecting the urgent call is received at the reception device 1200, the reception device 1200 may transmit a SIP response code (for example, 200 OK) to the SIP server 2000, and the SIP server 2000 may transmit the SIP response code (for example, 200 OK) to the electronic device 1001. The SIP response code (for example, 200 OK) may be a code for requesting connection of the urgent call.

In response to it being determined that the reception device 1200 supports the urgent notification function, the electronic device 1001 may identify whether the SIP response code (for example, 200 OK) requesting connection of the urgent call is received. In response to it being determined that the reception device 1200 supports the urgent notification function, the electronic device 1001 may wait for reception of the SIP response code (for example, 200 OK) requesting connection of the urgent call.

The electronic device 1001 may establish a realtime transport protocol (RTP) session for the urgent call with the reception device 1200. In response to the RTP session being established, the electronic device 1001 may perform the urgent call with the reception device 1200.

According to an embodiment, when the electronic device 1001 of FIG. 11 is the reception device 1200, the electronic device 1001 may acquire a SIP invite message provided from the transmission device 1100 via the SIP server 200. The electronic device 1001 may identify information notifying that the call is urgent, which is included in the SIP invite message, and may determine whether the electronic device 1001 supports the function of notifying the user of the urgent call.

When the electronic device 1001 supports the urgent notification function related to the SIP invite message provided from the transmission device 1100, the electronic device 1001 may identify the information indicating that the call is urgent, which is included in the SIP invite message. In response to the information indicating that the call is urgent being identified, the electronic device 1001 may determine that the r electronic device 1001 supports the urgent notification function. For example, the information indicating that the call is urgent, which is included in the SIP invite message, may be data of a pre-set format, and, when the electronic device 1001 supports the urgent notification function related to the SIP invite message provided from the transmission device 1100, the electronic device 1001 may interpret the data of the pre-set format.

When the electronic device 1001 does not support the urgent notification function related to the SIP invite message provided from the transmission device 1100, the electronic device 1001 may disregard the information indicating that the call is urgent, which is included in the SIP invite message. In response to the information indicating that the call is urgent being disregarded, the electronic device 1001 may determine that the electronic device 1001 does not support the urgent notification function. For example, the information indicating that the call is urgent, which is included in the SIP invite message, may be data of a pre-set format, and, when the electronic device 1001 does not support the urgent notification function related to the SIP invite message provided from the transmission device 1100, the electronic device 1001 may not interpret the data of the pre-set format.

In response to it being determined that the electronic device 1001 supports the urgent notification function, the electronic device 1001 may provide urgent notification support information to the SIP server 2000 along with a SIP response code, and the SIP server 2000 may provide the urgent notification support information to the transmission device 1100 along with the SIP response code.

The urgent notification support function may be information indicating that the electronic device 1001 supports the function of notifying the user of the urgent call. The urgent notification support information may be generated by the electronic device 1001 in response to it being determined that the electronic device 1001 supports the urgent notification function. The SIP response code may be a code that is provided as a response to the SIP invite message. The SIP response code may be, for example, a code of ‘180 ringing’.

The electronic device 1001 may determine whether an identification value of the transmission device 1100 is included in an urgent call list. The urgent call list may be a list of devices which are targets of the urgent notification related to the urgent call. The urgent call list may include, for example, a phone number of a device, a SSID, a model name and a name of a user of a device, a service ID, but is not limited thereto. For example, the electronic device 1001 may compare the phone number of the transmission device 1100, which transmits the SIP invite message for the urgent call, with phone numbers of devices in the urgent call list.

The electronic device 1001 may generate an urgent notification for connecting the urgent call. The urgent notification for notifying the user of the urgent call may include, for example, at least one of a text, an image or a sound.

The electronic device 1001 may output the urgent notification for connecting the urgent call. The electronic device 1001 may output the urgent notification in the middle of outputting at least one of a sound, a graphical user interface (GUI), or a vibration notifying call reception at the electronic device 1001. For example, the electronic device 1001 may output the urgent notification independently from the sound, GUI, and vibration notifying call reception. Alternatively, the electronic device 1001 may output the urgent notification as a part of the sound, GUI, and vibration notifying call reception.

In response to it being determined that the electronic device 1001 does not support the urgent notification function, the electronic device 1001 may provide only the SIP response code to the SIP server 2000 as a response to the urgent call. The electronic device 1001 may provide only the SIP response code without the urgent notification support information to the SIP server 2000 as a response to the urgent call. The electronic device 1001 may provide only the SIP response code without the urgent notification support information to the SIP server 2000 as a response to the urgent call. The SIP response code provided to the SIP server 2000 may be provided to the transmission device 1100 from the SIP server 2000.

The electronic device 1001 may receive a text message from the transmission device 1100. The electronic device 1001 may display the received text message on the display of The electronic device 1001. The text message notifying the urgent call, received from the transmission device 1100, may be the urgent text message, and the content of the text message may be forced to be displayed on the screen of The electronic device 1001. For example, while displaying a GUI indicting that the call request is received from the transmission device 1100 on the display of the electronic device 1001, the electronic device 1001 may be forced to display the content of the urgent text message on the GUI indicating that the call request is received from the transmission device 1100. For example, the content of the urgent text message may overlap the GUI indicating that the call request is received.

The electronic device 1001 may determine whether a user input for connecting the call is received. The electronic device 1001 may receive a user input for connecting the call with the transmission device 1100 via the GUI indicating that the call request is received from the transmission device 1100.

When the user input for connecting the call is received, the electronic device 1001 may transmit a SIP response code (for example, 200 OK) to the SIP server 2000, and the SIP server 2000 may transmit the SIP response code (for example, 200 OK) to the transmission device 1100 in operation S375. The SIP response code (for example, 200 OK) may be a code for requesting connection of the urgent call.

In response to the SIP response code (for example, 200 OK) transmitted to the transmission device 1100 being identified by the transmission device 1100, a realtime transport protocol (RTP) session for the urgent call may be established between the transmission device 1100 and the electronic device 1001. In response to the RTP session being established, the electronic device 1001 may perform the urgent call with the transmission device 1100.

According to an embodiment, when the electronic device 1001 of FIG. 11 is the reception device 1200 and the user input for connecting the call with the transmission device 1100 is not received, the electronic device 1001 may identify a priority level of the SIP invite message. When it is determined that the user input for connecting the call is not received for a first threshold, the electronic device 1001 may identify a priority level included in the SIP invite message. The electronic device 1001 may identify the priority of the urgent call by identifying the priority level.

The electronic device 1001 may determine whether a waiting time for the urgent call request exceeds a second threshold corresponding to the identified priority level. The waiting time for the urgent call request may be an amount of time that the electronic device 1001 waits to receive the user input for requesting the urgent call after receiving the SIP invite message for the urgent call.

The second threshold may be set differently depending on the priority level. For example, the second threshold corresponding to a high priority level may have a smaller value than the second threshold corresponding to a low priority level. For example, when the priority level is high and the urgency of the urgent call is high, the second threshold may be set to a relatively low value. For example, when the priority level is low and the urgency of the urgent call is low, the second threshold may be set to a relatively high value.

When it is determined that the waiting time for the urgent call request exceeds the second threshold, the electronic device 1001 may notify the IoT server 3000 of the urgent call. The electronic device 1001 may transmit the urgent notification information notifying that the urgent call is received to the IoT server 3000. The urgent notification information may include, for example, a message indicating that the urgent call is received, identification information of the transmission device 1100, identification information of the electronic device 1001, a priority level of the urgent call, and a service ID of an IoT service, but is not limited thereto.

The IoT server 3000 may identify at least one IoT device 4000 registered at the IoT server 3000 by the user of the electronic device 1001, based on the identification information of the reception device 1200 and/or the service ID of the IoT service, which are included in the urgent notification information received from the electronic device 1001. In addition, the IoT server 3000 may notify the identified IoT device 4000 of the urgent call, based on the message indicating that the urgent call is received, the identification information of the transmission device 1100, the identification information of the electronic device 1001 and/or the priority level of the urgent call, which are included in the urgent notification information received from the electronic device 1001.

The electronic device 1001 may determine whether the history of the urgent call request from the transmission device 1100 remains in a missed call list. When the user input for connecting the urgent call from the transmission device 1100 is not received and the urgent call from the transmission device 1100 is missed, the history of the urgent call request from the transmission device 1100 may be recorded on the missed call list. The missed call list may be a list on which the history of the urgent call request is recorded.

After a designated time is elapsed after the urgent call from the transmission device 1100 is missed, the electronic device 1001 may determine whether the history of the urgent all request from the transmission device 1100 remains in the missed call list. The electronic device 1001 may determine whether the history of the urgent call request from the transmission device 1100 remains in the missed call list according to a designated period after the urgent call from the transmission device 1100 is missed.

When it is determined that the history of the urgent call request from the transmission device 1100 remains in the missed call list, the electronic device 1001 may notify the IoT server 3000 of the urgent call. The electronic device 1001 may transmit the urgent notification information notifying that the urgent call is received to the IoT server 3000. The urgent notification information may include, for example, a message indicating that the urgent call is received, identification information of the transmission device 1100, identification information of the electronic device 1001, a priority level of the urgent call, a service ID of an IoT service, but is not limited thereto.

The IoT server 3000 may identify at least one IoT device 4000 registered at the IoT server 3000 by the user of the electronic device 1001, based on the identification information of the electronic device 1001 and/or the service ID of the IoT service included in the urgent notification information received from the electronic device 1001. The IoT server 3000 may select the IoT device 4000 that is used by the user or located in the proximity of the user among the identified IoT devices 4000. To achieve this, the IoT server 3000 may receive information indicating a current execution state and information on a peripheral device communicably connected from the IoT device 4000.

The IoT server 3000 may notify the IoT device 4000 of the urgent call, based on the message indicating that the urgent call is received, the identification information of the transmission device 1100, the identification information of the reception device 1200 and/or the priority level of the urgent call, which are included in the urgent notification information received from the electronic device 1001.

According to an embodiment, when the electronic device 1001 of FIG. 11 is the reception device 1200 and the electronic device 101 determines that the waiting time for the urgent call request exceeds a second threshold, the electronic device 1001 may notify the IoT device 4000 of the urgent call. The electronic device 1001 may transmit the urgent notification information notifying that the urgent call is received to the IoT device 4000. The urgent notification information may include, for example, a message indicating that the urgent call is received, identification information of the transmission device 1100, identification information of the electronic device 1001, and a priority level of the urgent call, but is not limited thereto.

The electronic device 1001 may identify at least one IoT device 4000 registered by the user. The electronic device 1001 may select the IoT device 4000 that is used by the user or is located in the proximity of the electronic device 1001 among the identified IoT devices 4000. To achieve this, the electronic device 1001 may receive information indicating a current execution state and information on a communicably connected peripheral device from the IoT device 4000.

When it is determined that the history of the urgent call request from the transmission device 1100 remains in the missed call list, the electronic device 1001 may notify the IoT device 4000 of the urgent call. The electronic device 1001 may transmit the urgent notification information notifying that the urgent call is received to the IoT device 4000. The urgent notification information may include, for example, a message indicating that the urgent call is received, identification information of the transmission device 1100, identification information of the electronic device 1001, and a priority level of the urgent call, but is not limited thereto.

The electronic device 1001 may identify at least one IoT device 4000 registered by the user. The electronic device 1001 may select the IoT device 4000 that is used by the user or is located in the proximity of the electronic device 1001 among the identified IoT devices 4000. To achieve this, the electronic device 1001 may receive information indicating a current execution state and information on a communicably connected peripheral device from the IoT device 4000.

Embodiments of the disclosure may also be implemented in the form of a recording medium including instructions that are executable by a computer, such as a program module executed by a computer. A computer-readable medium may be a certain available medium that is accessible by a computer, and may include both volatile and non-volatile media, removable and non-removable media. In addition, the computer-readable medium may include a computer storage medium and a communication medium. The computer storage medium includes volatile and non-volatile, removable and non-removable media implemented by a certain method or technique for storing information, such as computer-readable instructions, data structures, program modules, or other data. The communication medium may typically include other data in a modulated data signal, such as computer-readable instructions, data structures, or program modules.

The term “unit” or “module” used in the disclosure refer to a hardware component such as a processor or a circuit, and/or a software component executed by a hardware component such as a processor.

A “unit”, “module” may be implemented by a program that is stored in a storage medium which may be addressed, and is executed by a processor. For example, a “unit”, “module” may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters.

Execution explained in the disclosure is merely an example, and the scope of the disclosure is not limited by any method. For the sake of clarity of the disclosure, descriptions of related-art electronic components, control systems, software, and other functional aspects of the systems may be omitted.

In the disclosure, such phrase as “including at least one of a, b, or c” may refer to “including only a”, “including only b”, “including only c”, “including a and b”, “including b and c, “including a and c”, “including all of a, b, c”.

The above descriptions of the disclosure are simply for illustrative purposes, and it will be understood by those skilled in the art that embodiments may be readily changed to other specific forms without changing the technical ideas or essential features of the disclosure. It should therefore be understood that the various embodiments described above are examples in all aspects and are not intended to be limiting. For example, each component described in a single form may be implemented in a distributed manner, and similarly, components described as being distributed may be implemented in a combined form.

The scope of the disclosure includes the appended claims, and all changes or modified forms derived from the claims and equivalents to the claims should be understood as being included in the scope of the disclosure. It will also be understood that any of the embodiment(s) described herein may be used in conjunction with any other embodiment(s) described herein.

What is claimed is:

1. A device configured to provide a notification for an urgent call from a transmission device, the device comprising:
a communication interface comprising communication circuitry;
a memory configured to store instructions; and
at least one processor, comprising processing circuitry, operatively connected with the communication interface and the memory and individually and/or collectively, configured to execute the instructions, and to cause the device to:
receive a session initiation protocol (SIP) invite message for the urgent call generated at the transmission device from an SIP server;
in response to the SIP invite message being received, identify that an urgent notification function providing a notification of the urgent call based on the SIP invite message is supported by the device;
in response to identifying that the urgent notification function is supported, acquire urgent notification support information indicating that the urgent notification function is supported;
transmit an SIP response code as to the SIP invite message to the SIP server along with the urgent notification support information, the transmitted SIP response code and the urgent notification support information being provided to the transmission device from the SIP server;
in response to identifying that the urgent notification function is supported, output an urgent notification providing a notification that the SIP invite message for the urgent call is received;
receive an input for connecting the urgent call; and
establish a session for the urgent call with the transmission device.

2. The device of claim 1, wherein the SIP response code as to the SIP invite message is a code including ‘180: Ringing’, and
wherein the urgent notification support information is transmitted to the SIP server along with the code of ‘180: Ringing’ as a response to the SIP invite message.

3. The device of claim 1, wherein the transmission device is configured to use the urgent notification support information provided along with the SIP response code to identify whether the device supports the urgent notification.

4. The device of claim 1, wherein, at least one processor, individually and/or collectively, is configured to cause the device to:
in response to identifying that the urgent notification function is supported, acquire a device list including a target of the urgent notification;
determine whether an identification value of the transmission device is included in the device list; and
based on the identification value of the transmission device being included in the device list, generate the urgent notification.

5. The device of claim 1, wherein, at least one processor, individually and/or collectively, is configured to cause the device to: transmit only the SIP response code as to the SIP invite message to the SIP server in response to identifying that the urgent notification function is not supported,
wherein the transmitted SIP response code is provided to the transmission device from the SIP server.

6. The device of claim 5, wherein, at least one processor, individually and/or collectively, is configured to cause the device to: receive a text message notifying the urgent call from the transmission device based on only the SIP response code as to the SIP invite message being provided to the transmission device, and
wherein the text message notifying the urgent call is transmitted to the device by the transmission device in response to identifying by the transmission device that only the SIP response code is provided to the transmission device.

7. The device of claim 1, wherein, at least one processor, individually and/or collectively, is configured to cause the device to: transmit a SIP response code for connecting the urgent call to the SIP server in response to an input for connecting the urgent call being received, and
wherein the SIP response code for connecting the urgent call includes a code of ‘200: OK’.

8. The device of claim 1, wherein, at least one processor, individually and/or collectively, is configured to cause the device to: identify a waiting time for the input for connecting the urgent call, and provide an urgent notification notifying that the urgent call is received to another device in response to the waiting time exceeding a designated threshold value.

9. The device of claim 8, wherein the urgent notification provided to the another device is output from the another device for a specified time before the session for the urgent call is established.

10. The device of claim 8, wherein, at least one processor, individually and/or collectively, is configured to cause the device to request an IoT server configured to manage other devices to provide the urgent notification.

11. A method of operating a reception device configured to provide a notification for an urgent call, the method comprising:
receiving, from a session initiation protocol (SIP) server, an SIP invite message for the urgent call generated at a transmission device;
in response to the SIP invite message being received, identifying that an urgent notification function providing a notification of the urgent call based on the SIP invite message is supported by the reception device;
in response to identifying that the urgent notification function is supported, acquiring urgent notification support information indicating that the urgent notification function is supported;
transmitting an SIP response code as to the SIP invite message to the SIP server along with the urgent notification support information, the transmitted SIP response code and the urgent notification support information being provided to the transmission device from the SIP server;
in response to identifying that the urgent notification function is supported, outputting an urgent notification providing a notification that the SIP invite message for the urgent call is received;
receiving an input for connecting the urgent call; and
establishing a session for the urgent call with the transmission device.

12. The device of claim 11, wherein the SIP response code as to the SIP invite message is a code including ‘180: Ringing’, and
wherein the urgent notification support information is transmitted to the SIP server along with the code of ‘180: Ringing’ as a response to the SIP invite message.

13. The method of claim 11, wherein the urgent notification support information provided along with the SIP response code is used by the transmission device to identify whether the reception device supports the urgent notification.

14. The method of claim 11, further comprising, in response to identifying that the urgent notification function is supported:
acquiring a device list including a target of the urgent notification; and
determining whether an identification value of the transmission device is included in the device list,
wherein generating the urgent notification comprises, based on the identification value of the transmission device being included in the device list, generating the urgent notification.

15. The method of claim 11, wherein, in response to identifying that the urgent notification function is not supported, only the SIP response code as to the SIP invite message is transmitted to the SIP server, and the transmitted SIP response code is provided to the transmission device from the SIP server.

16. The method of claim 15, further comprising, based on only the SIP response code as to the SIP invite message being provided to the transmission device, receiving a text message providing a notification of the urgent call from the transmission device,
wherein the text message providing a notification of the urgent call is transmitted to the reception device by the transmission device in response to identifying by the transmission device that only the SIP response code is provided to the transmission device.

17. The method of claim 11, further comprising:
transmitting a SIP response code for connecting the urgent call to the SIP server in response to an input for connecting the urgent call being received, and
wherein the SIP response code for connecting the urgent call includes a code of ‘200: OK’.

18. The method of claim 11, further comprising:
identifying a waiting time for the input for connecting the urgent call; and
providing an urgent notification notifying that the urgent call is received to another device in response to the waiting time exceeding a designated threshold value.

19. The method of claim 18, wherein the urgent notification provided to the another device is output from the another device for a specified time before the session for the urgent call is established.

20. The method of claim 18, further comprising:
requesting an IoT server configured to manage other devices to provide the urgent notification.
